(19) United States
(12) Patent Application Publication
(10) Pub. No.: US 2016/0165896 A1
(43) Pub. Date: Jun. 16, 2016

(54) APPLICATION OF MIXOTROPHIC CHLORELLA FOR THE ACCELERATED EMERGENCE AND MATURATION OF SOLANACEAE PLANTS

(71) Applicant: Heliae Development, LLC, Gilbert, AZ (US)

(72) Inventors: Sandip SHINDE, Gilbert, AZ (US); Nicholas DONOWITZ, Shelburne, VT (US); Michael Clint ROHLFSEN, Edina, MN (US)

(21) Appl. No.: 14/602,356

(22) Filed: Jan. 22, 2015

Related U.S. Application Data
(60) Provisional application No. 62/092,774, filed on Dec. 16, 2014.

(51) Int. Cl. A01N 63/00

(52) U.S. Cl. CPC A01N 63/00

(57) ABSTRACT

Methods of accelerating emergence and maturation of plants in the Solanaceae family by administering an effective amount of a mixotrophic Chlorella based liquid composition in low concentration applications are disclosed. The administration may comprise soil applications of the composition.

### CROSS REFERENCE TO RELATED APPLICATIONS

This application claims the benefit of U.S. Provisional Application No. 62/092,774, filed Dec. 16, 2014, entitled Application of Mixotrophic Chlorella for the Accelerated Emergence and Maturation of Solanaceae Plants, the entire contents of which are hereby incorporated by reference herein.

### BACKGROUND

Seed emergence occurs as an immature plant breaks out of its seed coat, typically followed by the rising of a stem out of the soil. The first leaves that appear on many seedlings are the so-called seed leaves, or cotyledons, which often bear little resemblance to the later leaves. Shortly after the first true leaves, which are more or less typical of the plant, appear, the cotyledons will drop off. Germination of seeds is a complex physiological process triggered by imbibition of water after possible dormancy mechanisms have been released by appropriate triggers. Under favorable conditions rapid expansion growth of the embryo culminates in rupture of the covering layers and emergence of the radicle. A number of agents have been proposed as modulators of seed emergence. Temperature and moisture modulation are common methods of affecting seed emergence. Addition of nutrients to the soil has also been proposed to promote emergence of seeds of certain plants. The effectiveness may be attributable to the ingredients or the method of preparing the product. Increasing the effectiveness of a product may reduce the amount of the product needed and increase efficiency of the agricultural process.

### SUMMARY

In one non-limiting embodiment, a method for enhancing emergence of a Solanaceae plant from seed may comprise: administering a liquid composition treatment comprising a Chlorella culture in which the microalgae cell content of the culture consists essentially of whole pasteurized Chlorella cells in a concentration in of 0.003-0.080% solids by weight to a planted seed of a Solanaceae plant in an amount effective to enhance emergence of seeds, maturation, or both in a population of such seeds compared to seeds in a substantially identical population of untreated seeds.

In some embodiments, the administration comprises contacting the soil in the immediate vicinity of the planted seed with an effective amount of the liquid composition. In some embodiments, the liquid composition may comprise 0.004-0.080% solids by weight of whole pasteurized Chlorella cells. In some embodiments, the liquid composition may be administered at a rate in the range of 50-150 gallons per acre.

In some embodiments, the administration may comprise: soaking the seed in water and drying the seed; and applying an effective amount of the liquid composition below a seed planting level in soil. In some embodiments, the seed may be soaked in water for a time period in the range of 90-150 minutes. In some embodiments, the liquid composition may comprise 0.008-0.080% solids by weight of whole pasteurized Chlorella cells.

In some embodiments, the Solanaceae plant may comprise a tomato plant. In some embodiments, the whole Chlorella cells may not be subjected to a drying process. In some embodiments, the liquid composition may further comprise stabilizing means suitable for plants. In some embodiments, the Chlorella cells may be cultured in mixotrophic conditions. In some embodiments, the Chlorella cells may be cultured in non-axenic mixotrophic conditions. In some embodiments, the liquid composition may not contain an active ingredient for enhancing emergence or maturation other than the culture of whole Chlorella cells.

In some embodiments, the number of plants emerged from the soil may be increased by at least 25% compared to a substantially identical population of untreated plants. In some embodiments, the number of plants demonstrating maturation by leaf formation may be increased by at least 20% compared to a substantially identical population of untreated plants.

In another non-limiting embodiment, a method of enhancing emergence of a Solanaceae plant from seed may comprise: providing a liquid composition treatment comprising a Chlorella culture in which the microalgae cell content of the culture consists essentially of whole pasteurized Chlorella cells in a concentration in the range of 5-30% solids by weight; diluting the liquid composition with water to a concentration in the range of 0.003-0.080% solids by weight of whole pasteurized Chlorella cells; and administering the liquid composition treatment to a planted seed of a Solanaceae plant in an amount effective to enhance emergence of seeds, maturation, or both in a population of such seeds compared to seeds in a substantially identical population of untreated seeds.

### DETAILED DESCRIPTION

The Solanaceae plant family includes a large number of agricultural crops, medicinal plants, spices, and ornamentals in it's over 2,500 species. Taxonomically classified in the Plantae kingdom, Tracheobionta (subkingdom), Spermatophyta (superdivision), Magnoliophyta (division), Manoliopsida (class), Asteridae (subclass), and Solanales (order), the Solanaceae family includes, but is not limited to, potatoes, tomatoes, eggplants, various peppers, tobacco, and petunias. Plants in the Solanaceae can be found on all the continents, excluding Antarctica, and thus have a widespread importance in agriculture across the globe.

Particularly important in the production of fruit from Solanaceae plants is the beginning stage of growth where the plant emerges and matures into establishment. A method of treating a seed, seedling, or plant to directly improve the germination, emergence, and maturation of the plant; or to indirectly enhance the microbial soil community surrounding the seed or seedling is therefore valuable starting the plant on the path to marketable production. The standard used for assessing emergence is the achievement of the hypocotyl stage, where a stem is visibly protruding from the soil. The standard used for assessing maturation is the achievement of the cotyledon stage, where two leaves visibly form on the emerged stem.

To achieve such improvements in emergence and maturation of Solanaceae plants, the inventors developed a method to treat such seeds with a low concentration liquid microalgae based composition. The microalgae of the liquid composition comprise Chlorella sp. cultured in mixotrophic conditions, which comprises a culture medium primary comprised of water with trace nutrients (e.g., nitrates, phosphates, vitamins, metals found in BG-11 recipe (available from UTEX The Culture Collection of Algae at the University of Texas at Austin, Austin, Tex.)), light as an energy source for photosynthesis, organic carbon (e.g., acetate, acetic acid) as both an energy source and a source of carbon. In some embodiments, the culture media may comprise BG-11 media or a media derived from BG-11 culture media (e.g., in which additional component(s) are added to the media and/or one or more elements of the media is increased by 5%, 10%, 15%, 20%, 25%, 33%, 50%, or more over unmodified BG-11 media). In some embodiments, the Chlorella may be cultured in non-axenic mixotrophic conditions in the presence of contaminating organisms, such as but not limited to bacteria. Methods of culturing such microalgae in non-axenic mixotrophic conditions may be found in WO2014/074769A2 (Ganuza, et al.), hereby incorporated by reference.

By artificially controlling aspects of the Chlorella culturing process such as the organic carbon feed (e.g., acetic acid, acetate), oxygen levels, pH, and light, the culturing process differs from the culturing process that Chlorella experiences in nature. In addition to controlling various aspects of the culturing process, intervention by human operators or automated systems occurs during the non-axenic mixotrophic culturing of Chlorella through contamination control methods to prevent the Chlorella from being overrun and outcompeted by contaminating organisms (e.g., fungi, bacteria). Contamination control methods for microalgae cultures are known in the art and such suitable contamination control methods for non-axenic mixotrophic microalgae cultures are disclosed in WO2014/074769A2 (Ganuza, et al.), hereby incorporated by reference. By intervening in the microalgae culturing process, the impact of the contaminating microorganisms can be mitigated by suppressing the proliferation of containing organism populations and the effect on the microalgal cells (e.g., lysing, infection, death, clumping). Thus through artificial control of aspects of the culturing process and intervening in the culturing process with contamination control methods, the Chlorella culture produced as a whole and used in the described inventive compositions differs from the culture that results from a Chlorella culturing process that occurs in nature.

During the mixotrophic culturing process the Chlorella culture may also comprise cell debris and compounds excreted from the Chlorella cells into the culture medium. The output of the Chlorella mixotrophic culturing process provides the active ingredient for composition that is applied to plants for improving yield and quality without separate addition to or supplementation of the composition with other active ingredients not found in the mixotrophic Chlorella whole cells and accompanying culture medium from the mixotrophic culturing process such as, but not limited to: non-Chlorella microalgae cells, microalgae extracts, macroalgae, macroalgae extracts, liquid fertilizers, granular fertilizers, mineral complexes (e.g., calcium, sodium, zinc, manganese, cobalt, silicon), fungi, bacteria, nematodes, protozoa, digestate solids, chemicals (e.g., ethanolamine, borax, boric acid), humic acid, nitrogen and nitrogen derivatives, phosphorus rock, pesticides, herbicides, insecticides, enzymes, plant fiber (e.g., coconut fiber).

Mixotrophic Chlorella is the dominate microalgae species in the liquid composition. In some embodiments, the microalgae population of the liquid composition is substantially mixotrophic Chlorella. In some embodiments, mixotrophic or non-mixotrophic Chlorella comprises at least 90% of the microalgae population of the liquid composition. In some embodiments, mixotrophic or non-mixotrophic Chlorella comprises at least 91% of the microalgae population of the liquid composition. In some embodiments, mixotrophic or non-mixotrophic Chlorella comprises at least 92% of the microalgae population of the liquid composition. In some embodiments, mixotrophic or non-mixotrophic Chlorella comprises at least 93% of the microalgae population of the liquid composition. In some embodiments, mixotrophic or non-mixotrophic Chlorella comprises at least 94% of the microalgae population of the liquid composition. In some embodiments, mixotrophic or non-mixotrophic Chlorella comprises at least 95% of the microalgae population of the liquid composition. In some embodiments, mixotrophic or non-mixotrophic Chlorella comprises at least 96% of the microalgae population of the liquid composition. In some embodiments, mixotrophic or non-mixotrophic Chlorella comprises at least 97% of the microalgae population of the liquid composition. In some embodiments, mixotrophic or non-mixotrophic Chlorella comprises at least 98% of the microalgae population of the liquid composition. In some embodiments, mixotrophic or non-mixotrophic Chlorella comprises at least 99% of the microalgae population of the liquid composition. Liquid compositions having at least 99% of a Chlorella microalgae strain (e.g., at least 99.3%, at least 99.5%, or even at least 99.9%), such as mixotrophic Chlorella, can be considered to have a single algal species in the liquid composition. In one aspect, the liquid composition lacks any detectable amount of any other microalgae species. In another aspect, the liquid composition lacks any amount of any other microorganism in the liquid composition other than the desired Chlorella microalgae (e.g., bacteria) that is above 1% of the composition by weight).

While separate active ingredients are not added to or supplemented in the mixotrophic Chlorella based composition, the liquid composition comprising the mixotrophic Chlorella whole cells and accompanying constituents from the culturing medium and process (e.g., trace nutrients, residual organic carbon, bacteria, cell debris, cell excretions) may be stabilized by heating and cooling in a pasteurization process. As shown in the Examples, the inventors found that the active ingredients of the mixotrophic Chlorella based composition maintained effectiveness in improving plant germination, emergence, and maturation when applied to Solanaceae plants after being subjected to the heating and cooling of a pasteurization process.

In some embodiments, the composition may be heated to a temperature in the range of 50-70° C. In some embodiments, the composition may be heated to a temperature in the range of 55-65° C. In some embodiments, the composition may be heated to a temperature in the range of 58-62° C. In some embodiments, the composition may be heated to a temperature in the range of 50-60° C. In some embodiments, the composition may be heated to a temperature in the range of 60-70° C.

In some embodiments, the composition may be heated for a time period in the range of 90-150 minutes. In some embodiments, the composition may be heated for a time period in the range of 110-130 minutes. In some embodiments, the composition may be heated for a time period in the range of 90-100 minutes. In some embodiments, the composition may be heated for a time period in the range of 100-110 minutes. In some embodiments, the composition may be heated for a time period in the range of 110-120 minutes. In some embodiments, the composition may be heated for a time period in the range of 120-130 minutes. In some embodiments, the composition may be heated for a time period in the range of 130-140 minutes. In some embodiments, the composition may be heated for a time period in the range of 140-150 minutes.

In some embodiments, the composition may be cooled to a temperature in the range of 35-45° C. In some embodiments, the composition may be cooled to a temperature in the range of 36-44° C. In some embodiments, the composition may be cooled to a temperature in the range of 37-43° C. In some embodiments, the composition may be cooled to a temperature in the range of 38-42° C. In some embodiments, the composition may be cooled to a temperature in the range of 39-41° C.

In some embodiments, the mixotrophic Chlorella may be previously frozen and thawed before inclusion in the liquid composition. In some embodiments, the mixotrophic Chlorella may not have been subjected to a previous freezing or thawing process. In some embodiments, the mixotrophic Chlorella whole cells have not been subjected to a drying process. The cell walls of the mixotrophic Chlorella of the composition have not been lysed or disrupted, and the mixotrophic Chlorella cells have not been subjected to an extraction process or process that pulverizes the cells. The mixotrophic Chlorella whole cells are not subjected to a purification process for isolating the mixotrophic Chlorella whole cells from the accompanying constituents of the culturing process (e.g., trace nutrients, residual organic carbon, bacteria, cell debris, cell excretions), and thus the whole output from the mixotrophic Chlorella culturing process comprising whole Chlorella cells, culture medium, cell excretions, cell debris, bacteria, residual organic carbon, and trace nutrients, is used in the liquid composition for application to plants. In some embodiments, the mixotrophic Chlorella whole cells and the accompanying constituents of the culturing process are concentrated in the composition. In some embodiments, the mixotrophic Chlorella whole cells and the accompanying constituents of the culturing process are diluted in the composition to a low concentration. The mixotrophic Chlorella whole cells of the composition are not fossilized. In some embodiments, the mixotrophic Chlorella whole cells are not maintained in a viable state in the composition for continued growth after the method of using the composition in a soil or foliar application. In some embodiments, the mixotrophic Chlorella base composition may be biologically inactive after the composition is prepared. In some embodiments, the mixotrophic Chlorella base composition may be substantially biologically inactive after the composition is prepared. In some embodiments, the mixotrophic Chlorella base composition may increase in biological activity after the prepared composition is exposed to air.

In some embodiments, the composition may comprise 5-30% solids by weight of whole mixotrophic Chlorella cells. In some embodiments, the composition may comprise 5-20% solids by weight of whole mixotrophic Chlorella cells. In some embodiments, the composition may comprise 5-15% solids by weight of whole mixotrophic Chlorella cells. In some embodiments, the composition may comprise 5-10% solids by weight of whole mixotrophic Chlorella cells. In some embodiments, the composition may comprise 10-20% solids by weight of whole mixotrophic Chlorella cells. In some embodiments, the composition may comprise 10-20% solids by weight of whole mixotrophic Chlorella cells. In some embodiments, the composition may comprise 20-30% solids by weight of whole mixotrophic Chlorella cells. In some embodiments, further dilution of the whole mixotrophic Chlorella cells percent solids by weight may be occur before application for low concentration applications of the composition.

In some embodiments, the composition may comprise less than 1% solids by weight of whole mixotrophic Chlorella cells. In some embodiments, the composition may comprise less than 0.9% solids by weight of whole mixotrophic Chlorella cells. In some embodiments, the composition may comprise less than 0.8% solids by weight of whole mixotrophic Chlorella cells. In some embodiments, the composition may comprise less than 0.7% solids by weight of whole mixotrophic Chlorella cells. In some embodiments, the composition may comprise less than 0.6% solids by weight of whole mixotrophic Chlorella cells. In some embodiments, the composition may comprise less than 0.5% solids by weight of whole mixotrophic Chlorella cells. In some embodiments, the composition may comprise less than 0.4% solids by weight of whole mixotrophic Chlorella cells. In some embodiments, the composition may comprise less than 0.3% solids by weight of whole mixotrophic Chlorella cells. In some embodiments, the composition may comprise less than 0.2% solids by weight of whole mixotrophic Chlorella cells. In some embodiments, the composition may comprise less than 0.1% solids by weight of whole mixotrophic Chlorella cells. In some embodiments, the effective amount in an application of the liquid composition for enhanced germination, emergence, or maturation may comprise a concentration of solids of mixotrophic Chlorella whole cells in the range of 0.002642-0.079252% (e.g., about 0.003% to about 0.080%), equivalent to a diluted concentration of 2-10 mL/gallon of a solution with an original percent solids of mixotrophic Chlorella whole cells in the range of 5-30%.

In some embodiments, the liquid composition may comprise low concentrations of bacteria contributing to the solids percentage of the composition in addition to the whole mixotrophic Chlorella cells. Examples of bacteria found in non-axenic mixotrophic conditions may be found in WO2014/074769A2 (Ganuza, et al.), hereby incorporated by reference. A live bacteria count may be determined using methods known in the art such as plate counts, plates counts using Petrifilm available from 3M (St. Paul, Minn.), spectrophotometric (turbidimetric) measurements, visual comparison of turbidity with a known standard, direct cell counts under a microscope, cell mass determination, and measurement of cellular activity. Live bacteria counts in a non-axenic mixotrophic microalgae culture may range from 10⁴ to 10⁹ CFU/mL, and may depend on contamination control measures taken during the culturing of the microalgae. The level of bacteria in the composition may be determined by an aerobic plate count which quantifies aerobic colony forming units (CFU) in a designated volume. In some embodiments, the composition comprises an aerobic plate count of 40,000-400,000 CFU/mL. In some embodiments, the composition comprises an aerobic plate count of 40,000-100,000 CFU/mL. In some embodiments, the composition comprises an aerobic plate count of 100,000-200,000 CFU/mL. In some embodiments, the composition comprises an aerobic plate count of 200,000-300,000 CFU/mL. In some embodiments, the composition comprises an aerobic plate count of 300,000-400,000 CFU/mL.

In some embodiments, stabilizing means that are not active regarding the improvement of plant germination, emergence, and maturation, but instead aid in stabilizing the composition may be added to prevent the proliferation of unwanted microorganisms (e.g., yeast, mold) and prolong shelf life. Such inactive but stabilizing means may comprise an acid, such as but not limited to phosphoric acid, and a yeast and mold inhibitor, such as but not limited to potassium sorbate. In some embodiments, the stabilizing means are suitable for plants and do not inhibit the growth or health of the plant. In the alternative, the stabilizing means may contribute to nutritional properties of the liquid composition, such as but not limited to, the levels of nitrogen, phosphorus, or potassium.

In some embodiments, the composition may comprise less than 0.3% phosphoric acid. In some embodiments, the composition may comprise 0.01-0.3% phosphoric acid. In some embodiments, the composition may comprise 0.05-0.25% phosphoric acid. In some embodiments, the composition may comprise 0.01-0.1% phosphoric acid. In some embodiments, the composition may comprise 0.1-0.2% phosphoric acid. In some embodiments, the composition may comprise 0.2-0.3% phosphoric acid.

In some embodiments, the composition may comprise less than 0.5% potassium sorbate. In some embodiments, the composition may comprise 0.01-0.5% potassium sorbate. In some embodiments, the composition may comprise 0.05-0.4% potassium sorbate. In some embodiments, the composition may comprise 0.01-0.1% potassium sorbate. In some embodiments, the composition may comprise 0.1-0.2% potassium sorbate. In some embodiments, the composition may comprise 0.2-0.3% potassium sorbate. In some embodiments, the composition may comprise 0.3-0.4% potassium sorbate. In some embodiments, the composition may comprise 0.4-0.5% potassium sorbate.

The composition is a liquid and substantially comprises of water. In some embodiments, the composition may comprise 70-95% water. In some embodiments, the composition may comprise 85-95% water. In some embodiments, the composition may comprise 70-75% water. In some embodiments, the composition may comprise 75-80% water. In some embodiments, the composition may comprise 80-85% water. In some embodiments, the composition may comprise 85-90% water. In some embodiments, the composition may comprise 90-95% water. The liquid nature and high water content of the composition facilitates administration of the composition in a variety of manners, such as but not limit to: flowing through an irrigation system, flowing through an above ground drip irrigation system, flowing through a buried drip irrigation system, flowing through a central pivot irrigation system, sprayers, sprinklers, and water cans.

The liquid composition may be used immediately after formulation, or may be stored in containers for later use. In some embodiments, the composition may be stored out of direct sunlight. In some embodiments, the composition may be refrigerated. In some embodiments, the composition may be stored at 1-10° C. In some embodiments, the composition may be stored at 1-3° C. In some embodiments, the composition may be stored at 3-5° C. In some embodiments, the composition may be stored at 5-8° C. In some embodiments, the composition may be stored at 8-10° C.

Administration of the liquid composition treatment to a Solanaceae seed or plant may be in an amount effective to produce an enhanced characteristic in plants compared to a substantially identical population of untreated seeds or plants. Such enhanced characteristics may comprise accelerated seed germination, accelerated seedling emergence, improved seedling emergence, improved leaf formation, accelerated leaf formation, improved plant maturation, and accelerated plant maturation. Non-limiting examples of such enhanced characteristics may comprise accelerated achievement of the hypocotyl stage, accelerated protrusion of a stem from the soil, accelerated achievement of the cotyledon stage, and accelerated leaf formation. Such enhanced characteristics may occur individually in a plant, or in combinations of multiple enhanced characteristics.

Surprisingly, the inventors found that administration of the described composition in low concentration applications was effective in producing enhanced characteristics in Solanaceae plants. In some embodiments, the liquid composition treatment is administered before the seed is planted. In some embodiments, the liquid composition treatment is administered at the time the seed is planted. In some embodiments, the liquid composition treatment is administered after the seed is planted.

In some embodiments, administration of the liquid composition may increase the number of plants emerged by 25-2000% compared to a substantially identical population of untreated seeds of plants. In some embodiments, administration of the liquid composition may increase the number of plants emerged by at least 25% compared to a substantially identical population of untreated seeds of plants. In some embodiments, administration of the liquid composition may increase the number of plants emerged by at least 30% compared to a substantially identical population of untreated seeds of plants. In some embodiments, administration of the liquid composition may increase the number of plants emerged by at least 40% compared to a substantially identical population of untreated seeds of plants. In some embodiments, administration of the liquid composition may increase the number of plants emerged by at least 50% compared to a substantially identical population of untreated seeds of plants. In some embodiments, administration of the liquid composition may increase the number of plants emerged by at least 60% compared to a substantially identical population of untreated seeds of plants. In some embodiments, administration of the liquid composition may increase the number of plants emerged by at least 70% compared to a substantially identical population of untreated seeds of plants. In some embodiments, administration of the liquid composition may increase the number of plants emerged by at least 80% compared to a substantially identical population of untreated seeds of plants. In some embodiments, administration of the liquid composition may increase the number of plants emerged by at least 90% compared to a substantially identical population of untreated seeds of plants.

In some embodiments, administration of the liquid composition may increase the number of plants emerged by at least 100% compared to a substantially identical population of untreated seeds of plants. In some embodiments, administration of the liquid composition may increase the number of plants emerged by at least 200% compared to a substantially identical population of untreated seeds of plants. In some embodiments, administration of the liquid composition may increase the number of plants emerged by at least 300% compared to a substantially identical population of untreated seeds of plants. In some embodiments, administration of the liquid composition may increase the number of plants emerged by at least 400% compared to a substantially identical population of untreated seeds of plants. In some embodiments, administration of the liquid composition may increase the number of plants emerged by at least 500% compared to a substantially identical population of untreated seeds of plants. In some embodiments, administration of the liquid composition may increase the number of plants emerged by at least 600% compared to a substantially identical population of untreated seeds of plants. In some embodiments, administration of the liquid composition may increase the number of plants emerged by at least 700% compared to a substantially identical population of untreated seeds of plants. In some embodiments, administration of the liquid composition may increase the number of plants emerged by at least 800% compared to a substantially identical population of untreated seeds of plants. In some embodiments, administration of the liquid composition may increase the number of plants emerged by at least 900% compared to a substantially identical population of untreated seeds of plants. In some embodiments, administration of the liquid composition may increase the number of plants emerged by at least 1,000% compared to a substantially identical population of untreated seeds of plants. In some embodiments, administration of the liquid composition may increase the number of plants emerged by at least 1,500% compared to a substantially identical population of untreated seeds of plants.

In some embodiments, administration of the liquid composition may increase the number plants demonstrating maturation by leaf formation by 20-350% compared to a substantially identical population of untreated seeds of plants. In some embodiments, administration of the liquid composition may increase the number plants demonstrating maturation by leaf formation by at least 20% compared to a substantially identical population of untreated seeds of plants. In some embodiments, administration of the liquid composition may increase the number plants demonstrating maturation by leaf formation by at least 30% compared to a substantially identical population of untreated seeds of plants. In some embodiments, administration of the liquid composition may increase the number plants demonstrating maturation by leaf formation by at least 40% compared to a substantially identical population of untreated seeds of plants. In some embodiments, administration of the liquid composition may increase the number plants demonstrating maturation by leaf formation by at least 50% compared to a substantially identical population of untreated seeds of plants. In some embodiments, administration of the liquid composition may increase the number plants demonstrating maturation by leaf formation by at least 60% compared to a substantially identical population of untreated seeds of plants. In some embodiments, administration of the liquid composition may increase the number plants demonstrating maturation by leaf formation by at least 70% compared to a substantially identical population of untreated seeds of plants. In some embodiments, administration of the liquid composition may increase the number plants demonstrating maturation by leaf formation by at least 80% compared to a substantially identical population of untreated seeds of plants. In some embodiments, administration of the liquid composition may increase the number plants demonstrating maturation by leaf formation by at least 90% compared to a substantially identical population of untreated seeds of plants.

In some embodiments, administration of the liquid composition may increase the number plants demonstrating maturation by leaf formation by at least 100% compared to a substantially identical population of untreated seeds of plants. In some embodiments, administration of the liquid composition may increase the number plants demonstrating maturation by leaf formation by at least 150% compared to a substantially identical population of untreated seeds of plants. In some embodiments, administration of the liquid composition may increase the number plants demonstrating maturation by leaf formation by at least 200% compared to a substantially identical population of untreated seeds of plants. In some embodiments, administration of the liquid composition may increase the number plants demonstrating maturation by leaf formation by at least 250% compared to a substantially identical population of untreated seeds of plants. In some embodiments, administration of the liquid composition may increase the number plants demonstrating maturation by leaf formation by at least 300% compared to a substantially identical population of untreated seeds of plants.

### Seed Soak Application

In one non-limiting embodiment, the administration of the liquid composition treatment may comprise soaking the seed in an effective amount of the liquid composition before planting the seed. In some embodiments, the administration of the liquid composition further comprises removing the seed from the liquid composition after soaking, and drying the seed before planting. In some embodiments, the seed may be soaked in the liquid composition for a time period in the range of 90-150 minutes. In some embodiments, the seed may be soaked in the liquid composition for a time period in the range of 110-130 minutes. In some embodiments, the seed may be soaked in the liquid composition for a time period in the range of 90-100 minutes. In some embodiments, the seed may be soaked in the liquid composition for a time period in the range of 100-110 minutes. In some embodiments, the seed may be soaked in the liquid composition for a time period in the range of 110-120 minutes. In some embodiments, the seed may be soaked in the liquid composition for a time period in the range of 120-130 minutes. In some embodiments, the seed may be soaked in the liquid composition for a time period in the range of 130-140 minutes. In some embodiments, the seed may be soaked in the liquid composition for a time period in the range of 140-150 minutes.

The composition may be diluted to a lower concentration for an effective amount in a seed soak application by mixing a volume of the composition in a volume of water. The percent solids of mixotrophic Chlorella whole cells resulting in the diluted composition may be calculated by the multiplying the original percent solids in the composition by the ratio of the volume of the composition to the volume of water. In some embodiments, the effective amount in a seed soak application of the liquid composition may comprise a concentration in the range of 6-10 mL/gallon, resulting in a reduction of the percent solids of mixotrophic Chlorella whole cells from 5-30% to 0.007925-0.079252% (e.g., about 0.008% to about 0.080%). In some embodiments, the effective amount in a seed soak application of the liquid composition may comprise a concentration in the range of 7-9 mL/gallon, resulting in a reduction of the percent solids of mixotrophic Chlorella whole cells from 5-30% to 0.009245-0.071327% (e.g., about 0.009% to about 0.070%). In some embodiments, the effective amount in a seed soak application of the liquid composition may comprise a concentration in the range of 6-7 mL/gallon, resulting in a reduction of the percent solids of mixotrophic Chlorella whole cells from 5-30% to 0.007925-0.055476% (e.g., about 0.008% to about 0.055%). In some embodiments, the effective amount in a seed soak application of the liquid composition may comprise a concentration in the range of 7-8 mL/gallon, resulting in a reduction of the percent solids of mixotrophic Chlorella whole cells from 5-30% to 0.009246-0.063401% (e.g., about 0.009% to about 0.065%). In some embodiments, the effective amount in a seed soak application of the liquid composition may comprise a concentration in the range of 8-9 mL/gallon, resulting in a reduction of the percent solids of mixotrophic Chlorella whole cells from 5-30% to 0.010567-0.071327% (e.g., about 0.010% to about 0.070%). In some embodiments, the effective amount in a seed soak application of the liquid composition may comprise a concentration in the range of 9-10 mL/gallon, resulting in a reduction of the percent solids of mixotrophic Chlorella whole cells from 5-30% to 0.011888-0.079252% (e.g., about 0.012% to about 0.080%).

### Soil Application

In another non-limiting embodiment, the administration of the liquid composition treatment may comprise contacting the soil in the immediate vicinity of the planted seed with an effective amount of the liquid composition. In some embodiments, the liquid composition may be supplied to the soil by injection into a low volume irrigation system, such as but not limited to a drip irrigation system supplying water beneath the soil through perforated conduits or at the soil level by fluid conduits hanging above the ground or protruding from the ground. In some embodiments, the liquid composition may be supplied to the soil by a soil drench method wherein the liquid composition is poured on the soil.

The composition may be diluted to a lower concentration for an effective amount in a soil application by mixing a volume of the composition in a volume of water. The percent solids of mixotrophic Chlorella whole cells resulting in the diluted composition may be calculated by the multiplying the original percent solids in the composition by the ratio of the volume of the composition to the volume of water. In some embodiments, the effective amount in a soil application of the liquid composition may comprise a concentration in the range of 3.5-10 mL/gallon, resulting in a reduction of the percent solids of mixotrophic Chlorella whole cells from 5-30% to 0.004623-0.079252% (e.g., about 0.004% to about 0.080%). In some embodiments, the effective amount in a soil application of the liquid composition may comprise a concentration in the range of 3.5-4 mL/gallon, resulting in a reduction of the percent solids of mixotrophic Chlorella whole cells from 5-30% to 0.004623-0.031701% (e.g., about 0.004% to about 0.032%). In some embodiments, the effective amount in a soil application of the liquid composition may comprise a concentration in the range of 4-5 mL/gallon, resulting in a reduction of the percent solids of mixotrophic Chlorella whole cells from 5-30% to 0.005283-0.039626% (e.g., about 0.005% to about 0.040%). In some embodiments, the effective amount in a soil application of the liquid composition may comprise a concentration in the range of 5-6 mL/gallon, resulting in a reduction of the percent solids of mixotrophic Chlorella whole cells from 5-30% to 0.006604-0.047551% (e.g., about 0.006% to about 0.050%). In some embodiments, the effective amount in a soil application of the liquid composition may comprise a concentration in the range of 6-7 mL/gallon, resulting in a reduction of the percent solids of mixotrophic Chlorella whole cells from 5-30% to 0.007925-0.055476% (e.g., about 0.008% to about 0.055%). In some embodiments, the effective amount in a soil application of the liquid composition may comprise a concentration in the range of 7-8 mL/gallon, resulting in a reduction of the percent solids of mixotrophic Chlorella whole cells from 5-30% to 0.009246-0.063401% (e.g., about 0.009% to about 0.065%). In some embodiments, the effective amount in a soil application of the liquid composition may comprise a concentration in the range of 8-9 mL/gallon, resulting in a reduction of the percent solids of mixotrophic Chlorella whole cells from 5-30% to 0.010567-0.071327% (e.g., about 0.010% to about 0.075%). In some embodiments, the effective amount in a soil application of the liquid composition may comprise a concentration in the range of 9-10 mL/gallon, resulting in a reduction of the percent solids of mixotrophic Chlorella whole cells from 5-30% to 0.011888-0.079252% (e.g., about 0.012% to about 0.080%).

The rate of application of the composition at the desired concentration may be expressed as a volume per area. In some embodiments, the rate of application of the liquid composition in a soil application may comprise a rate in the range of 50-150 gallons/acre. In some embodiments, the rate of application of the liquid composition in a soil application may comprise a rate in the range of 75-125 gallons/acre. In some embodiments, the rate of application of the liquid composition in a soil application may comprise a rate in the range of 50-75 gallons/acre. In some embodiments, the rate of application of the liquid composition in a soil application may comprise a rate in the range of 75-100 gallons/acre. In some embodiments, the rate of application of the liquid composition in a soil application may comprise a rate in the range of 100-125 gallons/acre. In some embodiments, the rate of application of the liquid composition in a soil application may comprise a rate in the range of 125-150 gallons/acre.

### Capillary Action Application

In another non-limiting embodiment, the administration of the liquid composition treatment may comprise first soaking the seed in water, removing the seed from the water, drying the seed, applying an effective amount of the liquid composition below the seed planting level in the soil, and planting the seed, wherein the liquid composition supplied to the seed from below by capillary action. In some embodiments, the seed may be soaked in water for a time period in the range of 90-150 minutes. In some embodiments, the seed may be soaked in water for a time period in the range of 110-130 minutes. In some embodiments, the seed may be soaked in water for a time period in the range of 90-100 minutes. In some embodiments, the seed may be soaked in water for a time period in the range of 100-110 minutes. In some embodiments, the seed may be soaked in water for a time period in the range of 110-120 minutes. In some embodiments, the seed may be soaked in water for a time period in the range of 120-130 minutes. In some embodiments, the seed may be soaked in water for a time period in the range of 130-140 minutes. In some embodiments, the seed may be soaked in water for a time period in the range of 140-150 minutes.

The composition may be diluted to a lower concentration for an effective amount in a capillary action application by mixing a volume of the composition in a volume of water. The percent solids of mixotrophic Chlorella whole cells resulting in the diluted composition may be calculated by the multiplying the original percent solids in the composition by the ratio of the volume of the composition to the volume of water. In some embodiments, the effective amount in a capillary action application of the liquid composition may comprise a concentration in the range of 6-10 mL/gallon, resulting in a reduction of the percent solids of mixotrophic Chlorella whole cells from 5-30% to 0.007925-0.079252% (e.g., about 0.008% to about 0.080%). In some embodiments, the effective amount in a capillary action application of the liquid composition may comprise a concentration in the range of 7-9 mL/gallon, resulting in a reduction of the percent solids of mixotrophic Chlorella whole cells from 5-30% to 0.009245-0.071327% (e.g., about 0.009% to about 0.075%). In some embodiments, the effective amount in a capillary action application of the liquid composition may comprise a concentration in the range of 6-7 mL/gallon, resulting in a reduction of the percent solids of mixotrophic Chlorella whole cells from 5-30% to 0.007925-0.05547% (e.g., about 0.008% to about 0.055%). In some embodiments, the effective amount in a capillary action application of the liquid composition may comprise a concentration in the range of 7-8 mL/gallon, resulting in a reduction of the percent solids of mixotrophic Chlorella whole cells from 5-30% to 0.009246-0.063401% (e.g., about 0.009% to about 0.065%). In some embodiments, the effective amount in a capillary action application of the liquid composition may comprise a concentration in the range of 8-9 mL/gallon, resulting in a reduction of the percent solids of mixotrophic Chlorella whole cells from 5-30% to 0.010567-0.071327% (e.g., about 0.010% to about 0.075%). In some embodiments, the effective amount in a capillary action application of the liquid composition may comprise a concentration in the range of 9-10 mL/gallon, resulting in a reduction of the percent solids of mixotrophic Chlorella whole cells from 5-30% to 0.011888-0.079252% (e.g., about 0.012% to about 0.080%).

Whether in a seed soak, soil, or capillary action application the method of use comprises relatively low concentrations of the liquid composition. Even at such low concentrations, the described composition has been shown to be effective at producing an enhanced characteristic in Solanaceae plants. The ability to use low concentrations allows for a reduced impact on the environment that may result from over application and an increased efficiency in the method of use of the liquid composition by requiring a small amount of material to produce the desired effect. In some embodiments, the use of the liquid composition with a low volume irrigation system in soil applications allows the low concentration of the liquid composition to remain effective and not be diluted to a point where the composition is no longer in at a concentration capable of producing the desired effect on the plants while also increasing the grower's water use efficiency. The ability to use low concentrations of mixotrophic Chlorella whole cells and lack of purification processes to isolate the cells also reduces the dewatering and processing needs of the microalgae which may be produced at low concentrations in the culturing stage, and thus increasing the energy efficiency in the method of preparing the product. The use of mixotrophic Chlorella whole cells that have not been previously subjected to processing to dry, extract, lyse, or otherwise disrupt the cell wall also increases energy efficiency in the method of preparing the product and allows the product to be produced in a quicker time frame.

### EXAMPLES

Embodiments of the invention are exemplified and additional embodiments are disclosed in further detail in the following Examples, which are not in any way intended to limit the scope of any aspect of the invention described herein.

### Example 1

An experiment was conducted to determine if application of a low concentration of a mixotrophic Chlorella based composition to tomato seeds planted in soil affected the rate at which the seedlings emerge from the soil. Tomatoes are part of the Solanaceae family. Tomato seeds (Solanum lycopersicum) were planted in trays with standard soilless plant potting soil mix. Ten treatments were compared to an untreated control (UTC) and are listed in Table 1, with treatments 3 and 9 being duplicates. The mixotrophic Chlorella based composition in treatments 3 and 9 was not subjected to a drying or lysing process, while the mixotrophic Chlorella based composition in treatment 2 was dried by a drum drier. The Haematococcus pluvialis extracted biomass was mechanically lysed before being subjected to a supercritical carbon dioxide extraction process. The mixotrophically cultured Galidieria sp. lysed cells were mechanically lysed. The BG-11 culture media treatment consisted of the same culture media used in the mixotrophic Chlorella culturing process. The centrifuged media treatment consisted of the cultured media separated from a mixotrophic Chlorella culture by centrifuge at the end of the culturing process (i.e., once the mixotrophic Chlorella was harvested). A commercially available macroalgae extract based product was obtained from Acadian Seaplants Limited (30 Brown Avenue, Dartmouth, Nova Scotia, Canada, B3B 1X8) for comparison. The commercially available product Transit Soil from FBSciences, Inc. (153 N Main Street, Ste 100, Collierville, Tenn. 38017) was also tested.

TABLE 1

| Treatment | |
|---|---|
| No. | Treatment Description |
| 1 | UTC - untreated water check |
| 2 | Mixotrophic Chlorella sp. - Drum Dried Whole Cells |
| 3 | Mixotrophic Chlorella sp. - Whole Cells |
| 4 | Phototrophic Haematococcus pluvialis - Extracted Biomass |
| 5 | Mixotrophic Galdieria sp. - Whole Cells |
| 6 | Mixotrophic Galdieria sp. - Lysed Cells |
| 7 | Centrifuged Media from Mixotrophic Chlorella sp. culture |
| 8 | BG-11 Culture Media |
| 9 | Mixotrophic Chlorella sp. - Whole Cells |
| 10 | Grower Standard Product - Acadian Liquid Seaweed |
| | Concentrate |
| 11 | Grower Standard Product - Transit Soil |

The treatments were pasteurized, normalized to 10% solids (for treatments with microalgal solids), and stabilized with phosphoric acid (H₃PO₄) and potassium sorbate (C₆H₇KO₂), with the remaining balance consisting of water. The mixotrophic Chlorella based composition was previously frozen and thawed, and was incorporated into the liquid composition for treatments used in this experiment after cold storage following being harvested from the microalgae culturing system. The mixotrophic Chlorella based compositions used in the treatments of this experiment were not analyzed to quantify bacteria in the compositions, however aerobic plate counts for previous compositions prepared with the same components in the same manner contained 40,000-400,000 CFU/mL.

All treatments were applied to the seeds at the low concentration of 4.73 mL/gallon. The treatment method consisted of drenching the soil at a rate of 100 gallons/acre using a watering can. The treatments were applied immediately after planting the seeds. The tested concentration of 4.73 mL/gallon diluted the composition which originally contained 10% solids by weight of mixotrophic Chlorella whole cells to the low percent solids content of only 0.012495%.

Each treatment was applied to 100 seeds planted in a 10 by 10 pattern in planting trays, with each row of ten counting as a replicate (10 total replicates). Visual observations were made daily to record the percentage of plants that have emerged from the soil. The standard used for assessing emergence was the hypocotyl stage where a stem was visible to be protruding from the potting soil mix. The experiment was conducted inside a greenhouse with all seeds and treatments subjected to the same controlled conditions including temperature and light. All trays were treated with the same amount of water throughout the experiment. No additional nutrients were provided to the plants during the experiment. All data rated as significant was done so utilizing the New Duncan's Multiple Test Range at a 90% confidence level, such that values with a statistical significant identifier of the same letter are not significantly different.

Results are shown in Tables 2-5 with accompanying statistical significance grouping identifiers.

TABLE 2
Plant Emergence (Ave. % of plants emerged on date)

| | Day 1 | | | | Day 2 | | | | Day 3 | | | |
|---|---|---|---|---|---|---|---|---|---|---|---|---|
| | AM | | PM | | AM | | PM | | AM | | PM | |
| 1 | 0 | a | 0 | c | 0 | d | 2 | f | 3 | d | 16 | d |
| 2 | 0 | a | 0 | c | 0 | d | 1 | f | 2 | d | 21 | d |
| 3 | 0 | a | 3 | c | 6 | c | 24 | d | 23 | bcd | 60 | b |
| 4 | 0 | a | 3 | c | 4 | c | 24 | d | 26 | bcd | 60 | b |
| 5 | 0 | a | 0 | c | 0 | d | 5 | f | 6 | d | 45 | c |
| 6 | 0 | a | 0 | c | 0 | d | 5 | f | 5 | d | 44 | c |
| 7 | 0 | a | 0 | c | 0 | d | 7 | f | 10 | d | 43 | c |
| 8 | 0 | a | 0 | c | 0 | d | 10 | ef | 10 | d | 49 | bc |
| 9 | 0 | a | 8 | ab | 10 | ab | 42 | b | 45 | ab | 72 | a |
| 10 | 0 | a | 0 | c | 0 | d | 18 | de | 19 | cd | 6 | b |
| 11 | 0 | a | 0 | c | 0 | d | 16 | de | 44 | ab | 44 | c |

TABLE 3

| | Plant Emergence (Ave. % of plants emerged on date) | | | | | | | | | | | |
|---|---|---|---|---|---|---|---|---|---|---|---|---|
| | Day 4 | | | | Day 5 | | | | Day 6 | | Day 7 | |
| | AM | | PM | | AM | | PM | | PM | | PM | |
| 1 | 17 | g | 47 | g | 55 | e | 76 | a | 83 | a | 84 | a |
| 2 | 24 | g | 55 | fg | 56 | e | 77 | a | 84 | a | 87 | a |
| 3 | 65 | abc | 70 | b-e | 79 | abc | 83 | a | 82 | a | 78 | a |
| 4 | 61 | bcd | 73 | a-e | 79 | abc | 84 | a | 84 | a | 85 | a |
| 5 | 44 | ef | 64 | def | 64 | de | 82 | a | 83 | a | 88 | a |
| 6 | 43 | f | 61 | ef | 66 | cdc | 77 | a | 80 | a | 80 | a |
| 7 | 44 | ef | 64 | def | 73 | a-d | 82 | a | 81 | a | 83 | a |
| 8 | 56 | cde | 64 | def | 66 | cde | 77 | a | 74 | a | 77 | a |
| 9 | 73 | ab | 80 | ab | 83 | ab | 85 | a | 88 | a | 87 | a |
| 10 | 62 | bcd | 79 | abc | 79 | abc | 85 | a | 89 | a | 88 | a |
| 11 | 47 | ef | 68 | cde | 72 | a-d | 79 | a | 83 | a | 84 | a |

As shown in Tables 2-3, treatments 3 and 9 comprising the mixotrophic Chlorella based composition emerged out of the soil sooner than the UTC, the grower standard commercial products in treatments 10 and 11, and treatments 5-8, showing a statistically significance difference on Day 2 AM. The percentage of plants emerged for all treatments converged at the end of the experiment.

TABLE 4
Plant Emergence (Ave. % of plants emerged at observation time)

| | | Mixotrophic | | Mixotrophic | |
|---|---|---|---|---|---|
| | Untreated | Chlorella sp. | % | Chlorella sp. | |
| | Water | Whole Cells | Increase | Whole Cells | % |
| | Check | (Treatment | over | (Treatment | Increase |
| | (UTC) | 3) | UTC | 9) | over UTC |
| Day 1 AM | 0 a | 0 a | | 0 a | |
| Day 1 PM | 0 c | 3 c | | 8 ab | |
| Day 2 AM | 0 d | 6 d | | 10 ab | |
| Day 2 PM | 2 f | 24 d | 1100% | 42 b | 2000% |
| Day 3 AM | 3 d | 23 bcd | 667% | 45 ab | 1400% |
| Day 3 PM | 16 d | 60 b | 275% | 72 a | 350% |
| Day 4 AM | 17 g | 65 abc | 282% | 73 ab | 329% |
| Day 4 PM | 47 g | 70 b-e | 49% | 80 ab | 70% |
| Day 5 AM | 55 e | 79 abc | 44% | 83 ab | 51% |
| Day 5 PM | 76 a | 83 a | 9% | 85 a | 12% |
| Day 6 PM | 83 a | 82 a | −1% | 88 a | 6% |
| Day 7 PM | 84 a | 78 a | −7% | 87 a | 4% |

Table 4 shows treatments 3 and 9 comprising the mixotrophic Chlorella based composition with respect to the UTC. As shown in Table 4, treatments 3 and 9 began emerging from the soil on Day 1 PM, while the UTC treatment did not begin emergence until Day 2 PM and lagged behind treatments 3 and 9 by a statistically significant margin on most days until Day 5 PM. Of the plots receiving treatments comprising the mixotrophic Chlorella based composition, treatment 3 demonstrated a statistically significant difference from the UTC at Day 2 PM, Day 3 PM, Day 4 AM, Day 4 PM and Day 5 AM, and treatment 9 demonstrated a statistically significant difference from the UTC from Day 1 PM through Day 5 AM. Treatments 3 and 9 also reached at least 70% emergence a day before the UTC, and maintained a numerical increase of at least 27% over the UTC through Day 5 AM.

TABLE 5
Plant Emergence (Ave. % of plants emerged on Day 4 AM)

| | | | % |
|---|---|---|---|
| | 22-May | | increase |
| | AM | | over UTC |
| UTC - untreated water check | 17 | f | |
| Mixotrophic Chlorella sp. - Drum Dried | 24 | f | 41% |
| Whole Cells | | | |
| Mixotrophic Chlorella sp. - Whole Cells | 69 | ab | 306% |
| (Average) | | | |
| Phototrophic Haematococcus pluvialis - | 61 | bcd | 259% |
| Extracted Biomass | | | |
| Mixotrophic Galdieria sp. - Whole Cells | 44 | e | 159% |
| Mixotrophic Galdieria sp. - Lysed Cells | 43 | e | 153% |
| Centrifuged Media from Mixotrophic | 44 | e | 159% |
| Chlorella sp. culture | | | |
| BG-11 Culture Media | 56 | cde | 229% |
| Grower Standard Product - Acadian | 62 | abc | 265% |
| Liquid Seaweed Concentrate | | | |
| Grower Standard Product - Transit Soil | 47 | de | 176% |

Table 5 displays the data from the Day 4 AM with the duplicate mixotrophic Chlorella based composition treatments averaged for comparison to the other treatments, and shows a statistically significant difference for the mixotrophic Chlorella based composition which had not been dried (i.e., wet) as compared to the UTC, which amounts to a numerical increase of 306%. Table 5 also shows that the mixotrophic Chlorella based composition treatment that had not been dried treatment the commercially available products, and was significantly different from the mixotrophic Galdieria and drum dried mixotrophic Chlorella based composition treatments.

### Example 2

An experiment was conducted to determine if the method of application of a low concentration of a mixotrophic Chlorella based composition to tomato seeds planted in soil affected the rate at which the seedlings emerge from the soil and mature. Tomato seeds (Solanum lycopersicum) were planted in trays with a potting soil mix of sphagnum moss, perlite, and vermiculite (2:1:1). Three treatments comprising a mixotrophic Chlorella based composition were compared to an untreated control (UTC). The treatments were pasteurized, normalized to 10% solids, and stabilized with phosphoric acid (H₃PO₄) and potassium sorbate (C₆H₇KO₂), with the remaining balance consisting of water. The stored mixotrophic Chlorella based composition was frozen after being harvested from the microalgae culturing system and thawed before formulation in the liquid composition for treatments used in the experiment. The fresh mixotrophic Chlorella based composition was not previously frozen, and was incorporated into the liquid composition for treatments used in this experiment directly after being harvested from the microalgae culturing system. The composition used in the treatments of this experiment were not analyzed to quantify bacteria in the compositions, however aerobic plate counts for previous compositions prepared with the same components in the same manner contained 40,000-400,000 CFU/mL.

The mixotrophic Chlorella based liquid composition treatments were applied to the seeds through two different treatment methods. The first treatment method comprised soaking the seeds in the low concentration of 8 mL/gallon of the mixotrophic Chlorella based liquid composition for two hours with constant sparging of air to avoid oxygen deprivation, removing the seeds from the composition, drying the seeds overnight, and then planting the seeds in the potting soil mix. The second treatment method comprised soaking the seeds in water for two hours with constant sparing of air to avoid oxygen deprivation, removing the seeds from water, drying the seeds overnight, planting the seeds in the potting soil mix with the low concentration of 8 mL/gallon of the mixotrophic Chlorella based liquid composition in the base of the planting tray to allow the seeds to be treated with the liquid composition through capillary action. The tested concentration of 8 mL/gallon diluted the composition which originally contained 10% solids by weight of mixotrophic Chlorella whole cells to the low percent solids content of only 0.021134%.

Each of the three treatments were applied to 72 seeds. Visual observations of the soil and plants were made daily on days 6 and 7 to record how many seeds had achieved emergence and maturation, as explained below. The standard used for assessing emergence was the achievement of the hypocotyl stage, where a stem was visibly protruding from the potting soil mix. The standard used for assessing maturation was the achievement of the cotyledon stage, where two leaves had visibly formed on the emerged stem. The experiment was conducted indoors with all seeds and treatments subjected to the same controlled conditions including temperature, light, and supply of water. No other nutrients were supplied during the experiment. Light supplied was artificial and provided by fluorescent bulbs 24 hours a day. Results of the experiment are presented in Tables 6-11.

TABLE 6

Number of plants
emerged by day

| | Day 6 | Day 7 |
|---|---|---|
| Untreated Control (UTC) | 28 | 42 |
| 10% Mixotrophic | 22 | 46 |
| Chlorella Fresh Soak | | |
| 10% Mixotrophic | 26 | 47 |
| Chlorella Stored Soak | | |
| 10% Mixotrophic | 43 | 58 |
| Chlorella Fresh Capillary | | |

TABLE 7

% of total plants
emerged by day

| | Day 6 | Day 7 |
|---|---|---|
| Untreated Control (UTC) | 39 | 58 |
| 10% Mixotrophic | 31 | 64 |
| Chlorella Fresh Soak | | |
| 10% Mixotrophic | 36 | 65 |
| Chlorella Stored Soak | | |
| 10% Mixotrophic | 60 | 81 |
| Chlorella Fresh Capillary | | |

TABLE 8

% increase of plants
emerged by
day over UTC

| | Day 6 | Day 7 |
|---|---|---|
| 10% Mixotrophic | −21% | 10% |
| Chlorella Fresh Soak | | |
| 10% Mixotrophic | −7% | 12% |
| Chlorella Stored Soak | | |
| 10% Mixotrophic | 54% | 38% |
| Chlorella Fresh Capillary | | |

As shown in the Tables 6-8, the capillary action treatment and seed soak treatments showed higher performance by day seven than the UTC regarding emergence of the plants. On day seven the capillary action treatment showed an increase of 38%, the seed soak treatment with stored mixotrophic Chlorella based composition showed an increase of 12%, and the seed soak treatment with fresh mixotrophic Chlorella based composition showed an increase of 10% over the UTC. These results show that a low concentration of a mixotrophic Chlorella based composition is effective in increasing the emergence of a seedling as compared to an untreated seed when applied in a capillary action application.

TABLE 9

Number of plants
matured by day

| | Day 6 | Day 7 |
|---|---|---|
| Untreated Control (UTC) | 11 | 37 |
| 10% Mixotrophic | 18 | 41 |
| Chlorella Fresh Soak | | |
| 10% Mixotrophic | 18 | 39 |
| Chlorella Stored Soak | | |
| 10% Mixotrophic | 23 | 47 |
| Chlorella Fresh Capillary | | |

TABLE 10

% of total plants
matured by day

| | Day 6 | Day 7 |
|---|---|---|
| Untreated Control (UTC) | 15 | 51 |
| 10% Mixotrophic | 25 | 57 |
| Chlorella Fresh Soak | | |
| 10% Mixotrophic | 25 | 54 |
| Chlorella Stored Soak | | |
| 10% Mixotrophic | 32 | 65 |
| Chlorella Fresh Capillary | | |

TABLE 11

% increase of
plants matured by
day over the UTC

| | Day 6 | Day 7 |
|---|---|---|
| 10% Mixotrophic | 64% | 11% |
| Chlorella Fresh Soak | | |
| 10% Mixotrophic | 64% | 5% |
| Chlorella Stored Soak | | |
| 10% Mixotrophic | 109% | 27% |
| Chlorella Fresh Capillary | | |

As shown in the Tables 9-11, the capillary action treatment and seed soak treatments showed higher performance on days 6 and 7 than the UTC regarding maturation of the plants. The capillary action treatment showed an increase of at least 27%, the seed soak treatment with stored mixotrophic Chlorella based composition showed an increase of at least 5%, and the seed soak treatment with fresh mixotrophic Chlorella based composition showed an increase of at least 11% over the UTC. These results show that a low concentration of a mixotrophic Chlorella based composition is effective in increasing the maturation of a seedling as compared to an untreated seed when applied in a capillary action application.

### Example 3

An experiment was conducted to determine if the method of application of a low concentration of a mixotrophic Chlorella based composition to tomato seeds planted in soil affected the rate at which the seedlings emerge from the soil and mature. Tomato seeds (Solanum lycopersicum) were planted in trays with a potting soil mix of sphagnum moss, perlite, and vermiculite (2:1:1). Two treatments comprising mixotrophically cultured a mixotrophic Chlorella based composition were compared to an untreated control (UTC). The treatments were pasteurized, normalized to 10% solids, and stabilized with phosphoric acid (H₃PO₄) and potassium sorbate (C₆H₇KO₂), with the remaining balance consisting of water. The mixotrophic Chlorella based composition was not previously frozen, and was incorporated into the liquid composition for treatments used in this experiment directly after being harvested from the microalgae culturing system. The composition used in the treatments of this experiment was not analyzed to quantify bacteria in the composition, however aerobic plate counts for previous compositions prepared with the same components in the same manner contained 40,000-400,000 CFU/mL.

The mixotrophic Chlorella based liquid composition was applied to the seeds at two different concentrations, 4.7 mL/gallon or 8 mL/gallon, using the same treatment method. The tested concentration of 4.7 mL/gallon diluted the composition which originally contained 10% solids by weight of mixotrophic Chlorella whole cells to the low percent solids content of only 0.012416%. The tested concentration of 8 mL/gallon diluted the composition which originally contained 10% solids by weight of mixotrophic Chlorella whole cells to the low percent solids content of only 0.021134%. The treatment method consisted of drenching the soil from the top with 0.75 gallon of the liquid composition (equivalent to an application rate of 100 gallons/acre) at the identified concentrations after planting the seeds.

Each of the two treatments were applied to two trays of 72 seeds. Visual observations of the soil and plants were made daily to record how many seeds had achieved emergence and maturation, as explained below. The standard used for assessing emergence was the achievement of the hypocotyl stage where a stem was visibly protruding from the potting soil mix. The standard used for assessing maturation was the achievement of the cotyledon stage where two leaves had visibly formed on the emerged stem. The experiment was conducted indoors with all seeds and treatments subjected to the same controlled conditions including temperature, light, and supply of water. No other nutrients were supplied during the experiment. Light supplied was artificial and provided by fluorescent bulbs 24 hours a day. Results of the experiment are presented in Tables 12-17.

TABLE 12

| | Number of plants emerged by day | | | | | | | | |
|---|---|---|---|---|---|---|---|---|---|
| | 1 | 2 | 3 | 4 | 5 | 6 | 7 | 8 | 9 |
| Untreated Control | — | — | 0 | 0 | 0 | 10 | 40 | 43 | 69 |
| (UTC) | | | | | | | | | |
| 10% Mixotrophic | — | — | 0 | 0 | 0 | 20 | 57 | 62 | 87 |
| Chlorella 4.7 mL | | | | | | | | | |
| 10% Mixotrophic | — | — | 0 | 0 | 0 | 39 | 59 | 65 | 88 |
| Chlorella 8 mL | | | | | | | | | |

TABLE 13

| | % of total plants emerged by day | | | | | | | | |
|---|---|---|---|---|---|---|---|---|---|
| | 1 | 2 | 3 | 4 | 5 | 6 | 7 | 8 | 9 |
| Untreated Control | 0 | 0 | 0 | 0 | 0 | 7 | 28 | 30 | 48 |
| (UTC) | | | | | | | | | |
| 10% Mixotrophic | 0 | 0 | 0 | 0 | 0 | 14 | 40 | 43 | 60 |
| Chlorella 4.7 mL | | | | | | | | | |
| 10% Mixotrophic | 0 | 0 | 0 | 0 | 0 | 27 | 41 | 45 | 61 |
| Chlorella 8 mL | | | | | | | | | |

TABLE 14

| | % increase of plants emerged by day over the UTC | | | | | | | | |
|---|---|---|---|---|---|---|---|---|---|
| | 1 | 2 | 3 | 4 | 5 | 6 | 7 | 8 | 9 |
| 10% Mixotrophic | — | — | — | — | — | 100% | 43% | 44% | 26% |
| Chlorella 4.7 mL | | | | | | | | | |
| 10% Mixotrophic | — | — | — | — | — | 290% | 48% | 51% | 28% |
| Chlorella 8 mL | | | | | | | | | |

As shown in the Tables 12-14, the 8 and 4.7 mL/gallon applications showed consistently higher performance than the UTC regarding emergence of the plants, with the 8 mL/gallon application consistently performing better than the 4.7 mL/gallon. The 4.7 mL/gallon application showed at least a 26% and as much as a 100% increase over the UTC on comparative days, and the 8 mL/gallon application demonstrated at least a 28% and as much as a 290% increase over the UTC. The largest difference between the 4.7 and 8 mL/gallon applications occurred on day 6. These results show that a low concentration of a mixotrophic Chlorella based composition is effective in increasing the emergence of a seedling as compared to an untreated seed when applied in a soil drench application.

TABLE 15

| | Number of plants matured by day | | | | | | | | |
|---|---|---|---|---|---|---|---|---|---|
| | 1 | 2 | 3 | 4 | 5 | 6 | 7 | 8 | 9 |
| Untreated Control | — | — | 0 | 0 | 0 | 2 | 22 | 45 | 65 |
| (UTC) | | | | | | | | | |
| 10% Mixotrophic | — | — | 0 | 0 | 0 | 9 | 42 | 69 | 83 |
| Chlorella 4.7 mL | | | | | | | | | |
| 10% Mixotrophic | — | — | 0 | 0 | 0 | 8 | 46 | 68 | 79 |
| Chlorella 8 mL | | | | | | | | | |

TABLE 16

| | % of total plants matured by day | | | | | | | | |
|---|---|---|---|---|---|---|---|---|---|
| | 1 | 2 | 3 | 4 | 5 | 6 | 7 | 8 | 9 |
| Untreated Control | 0 | 0 | 0 | 0 | 0 | 1 | 15 | 31 | 45 |
| (UTC) | | | | | | | | | |
| 10% Mixotrophic | 0 | 0 | 0 | 0 | 0 | 6 | 29 | 48 | 58 |
| Chlorella 4.7 mL | | | | | | | | | |
| 10% Mixotrophic | 0 | 0 | 0 | 0 | 0 | 6 | 32 | 47 | 55 |
| Chlorella 8 mL | | | | | | | | | |

TABLE 17

| | % increase of plants matured by day over the UTC | | | | | | | | |
|---|---|---|---|---|---|---|---|---|---|
| | 1 | 2 | 3 | 4 | 5 | 6 | 7 | 8 | 9 |
| 10% Mixotrophic | — | — | — | — | — | 350% | 91% | 53% | 28% |
| Chlorella 4.7 mL | | | | | | | | | |
| 10% Mixotrophic | — | — | — | — | — | 300% | 109% | 51% | 22% |
| Chlorella 8 mL | | | | | | | | | |

As shown in the Tables 15-17, the 8 and 4.7 mL/gallon applications showed consistently higher performance than the UTC regarding maturation of the plants, with the 4.7 mL/gallon application performing better than the 8 mL/gallon on days 6, 8, and 9. The 4.7 mL/gallon application showed at least a 28% and as much as a 350% increase over the UTC on comparative days and the 8 mL/gallon application demonstrated at least a 22% and as much as a 300% increase over the UTC. These results show that a low concentration of a mixotrophic Chlorella based composition is effective in increasing the maturation of a seedling as compared to an untreated seed when applied in a soil drench application.

With the characteristics that are shared among plants within the Solanaceae plant family, the results shown in the Examples are likely representative as to the effectiveness of a mixotrophic Chlorella based composition as described throughout the specification on all plants in the Solanaceae plant family.

### ASPECTS OF THE INVENTION

In one non-limiting embodiment, a method for enhancing emergence of a Solanaceae plant from seed may comprise: administering a liquid composition treatment comprising a Chlorella culture in which the microalgae cell content of the culture consists essentially of whole pasteurized Chlorella cells in a concentration in of 0.003-0.080% solids by weight to a planted seed of a Solanaceae plant in an amount effective to enhance emergence of seeds, maturation, or both in a population of such seeds compared to seeds in a substantially identical population of untreated seeds.

In some embodiments, the administration may comprise soaking the seed in an effective amount of the liquid composition before planting the seed. In some embodiments, the seed may be soaked for a time period in the range of 90-150 minutes. In some embodiments, the liquid composition may comprise a concentration in the range of 0.008-0.080% solids by weight of whole pasteurized Chlorella cells. In some embodiments, the method may further comprise removing the seed from the liquid composition and drying the seed before planting the seed.

In some embodiments, the administration comprises contacting the soil in the immediate vicinity of the planted seed with an effective amount of the liquid composition. In some embodiments, the liquid composition may comprise 0.004-0.080% solids by weight of whole pasteurized Chlorella cells. In some embodiments, the liquid composition may be administered at a rate in the range of 50-150 gallons per acre.

In some embodiments, the administration may comprise: soaking the seed in water and drying the seed; and applying an effective amount of the liquid composition below a seed planting level in soil. In some embodiments, the seed may be soaked in water for a time period in the range of 90-150 minutes. In some embodiments, the liquid composition may comprise 0.008-0.080% solids by weight of whole pasteurized Chlorella cells.

In some embodiments, the Solanaceae plant may comprise a tomato plant. In some embodiments, the whole Chlorella cells may not be subjected to a drying process. In some embodiments, the liquid composition may further comprise stabilizing means suitable for plants. In some embodiments, the Chlorella cells may be cultured in mixotrophic conditions. In some embodiments, the Chlorella cells may be cultured in non-axenic mixotrophic conditions. In some embodiments, the liquid composition may not contain an active ingredient for enhancing emergence or maturation other than the culture of whole Chlorella cells.

In some embodiments, the number of plants emerged from the soil may be increased by at least 25% compared to a substantially identical population of untreated plants. In some embodiments, the number of plants demonstrating maturation by leaf formation may be increased by at least 20% compared to a substantially identical population of untreated plants.

In another non-limiting embodiment, a method of enhancing emergence of a Solanaceae plant from seed may comprise: providing a liquid composition treatment comprising a Chlorella culture in which the microalgae cell content of the culture consists essentially of whole pasteurized Chlorella cells in a concentration in the range of 5-30% solids by weight; diluting the liquid composition with water to a concentration in the range of 0.003-0.080% solids by weight of whole pasteurized Chlorella cells; and administering the liquid composition treatment to a planted seed of a Solanaceae plant in an amount effective to enhance emergence of seeds, maturation, or both in a population of such seeds compared to seeds in a substantially identical population of untreated seeds.

All references, including publications, patent applications, and patents, cited herein are hereby incorporated by reference in their entirety and to the same extent as if each reference were individually and specifically indicated to be incorporated by reference and were set forth in its entirety herein (to the maximum extent permitted by law), regardless of any separately provided incorporation of particular documents made elsewhere herein.

The use of the terms “a” and “an” and “the” and similar referents in the context of describing the invention are to be construed to cover both the singular and the plural, unless otherwise indicated herein or clearly contradicted by context.

Unless otherwise stated, all exact values provided herein are representative of corresponding approximate values (e.g., all exact exemplary values provided with respect to a particular factor or measurement can be considered to also provide a corresponding approximate measurement, modified by “about,” where appropriate). All provided ranges of values are intended to include the end points of the ranges, as well as values between the end points.

The description herein of any aspect or embodiment of the invention using terms such as “comprising”, “having,” “including,” or “containing” with reference to an element or elements is intended to provide support for a similar aspect or embodiment of the invention that “consists of”, “consists essentially of”, or “substantially comprises” that particular element or elements, unless otherwise stated or clearly contradicted by context (e.g., a composition described herein as comprising a particular element should be understood as also describing a composition consisting of that element, unless otherwise stated or clearly contradicted by context).

All headings and sub-headings are used herein for convenience only and should not be construed as limiting the invention in any way.

The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

The citation and incorporation of patent documents herein is done for convenience only and does not reflect any view of the validity, patentability, and/or enforceability of such patent documents.

This invention includes all modifications and equivalents of the subject matter recited in the claims and/or aspects appended hereto as permitted by applicable law.

1. A method for enhancing emergence of a Solanaceae plant from a seed, the method comprising: administering a liquid composition treatment comprising a Chlorella culture in which the microalgae cell content of the culture consists essentially of whole pasteurized Chlorella cells in a concentration in the range of 0.003-0.080% solids by weight to a planted seed of a Solanaceae plant in an amount effective to enhance emergence of seeds, maturation, or both in a population of such seeds compared to seeds in a substantially identical population of untreated seeds.

2. The method of claim 1, wherein the administration comprises contacting the soil in the immediate vicinity of the planted seed with an effective amount of the liquid composition treatment.

3. The method of claim 2, wherein the liquid composition treatment comprises 0.004-0.080% solids by weight of whole pasteurized Chlorella cells.

4. The method of claim 3, wherein the liquid composition treatment is administered at a rate in the range of 50-150 gallons per acre.

5. The method of claim 1, wherein the administration comprises:
a. Soaking the seed in water and drying the seed; and
b. Applying an effective amount of the liquid composition treatment below a seed planting level in soil.

6. The method of claim 5, wherein the seed is soaked in water for a time period in the range of 90-150 minutes.

7. The method of claim 5, wherein the liquid composition treatment comprises 0.008-0.080% solids by weight of whole pasteurized Chlorella cells.

8. The method of claim 1, wherein the Solanaceae plant comprises a tomato plant.

9. The method of claim 1, wherein the whole Chlorella cells have not been subjected to a drying process.

10. The method of claim 1, wherein the liquid composition treatment further comprises stabilizing means suitable for plants.

11. The method of claim 1, wherein the Chlorella cells are cultured in mixotrophic conditions.

12. The method of claim 11, wherein the Chlorella cells are cultured in non-axenic mixotrophic conditions.

13. The method of claim 1, wherein the liquid composition treatment does not contain an active ingredient for enhancing emergence or maturation other than the culture of whole Chlorella cells.

14. The method of claim 1, wherein the number of plants emerged from the soil is increased by at least 25% compared to a substantially identical population of untreated seeds of plants.

15. The method of claim 1, wherein the number of plants demonstrating maturation by leaf formation is increased by at least 20% compared to a substantially identical population of untreated seeds of plants.

16. A method of enhancing emergence of a Solanaceae plant from a seed, the method comprising:
a. Providing a liquid composition treatment comprising a Chlorella culture in which the microalgae cell content of the culture consists essentially of whole pasteurized Chlorella cells in a concentration in the range of 5-30% solids by weight;
b. Diluting the liquid composition treatment with water to a concentration in the range of 0.003-0.080% solids by weight of whole pasteurized Chlorella cells; and
c. Administering the liquid composition treatment to a planted seed of a Solanaceae plant in an amount effective to enhance emergence of seeds, maturation, or both in a population of such seeds compared to seeds in a substantially identical population of untreated seeds.

17. The method of claim 16, wherein the administration comprises contacting the soil in the immediate vicinity of the planted seed with an effective amount of the liquid composition treatment.

18. The method of claim 17, wherein the liquid composition treatment comprises 0.004-0.080% solids by weight of whole pasteurized Chlorella cells.

19. The method of claim 16, wherein the administration comprises:
a. Soaking the seed in water and drying the seed; and
b. Applying an effective amount of the liquid composition treatment below a seed planting level in soil.

20. The method of claim 19, wherein the diluted liquid composition treatment comprises 0.008-0.080% solids by weight of mixotrophically cultured whole Chlorella cells.

21. The method of claim 16, wherein the Solanaceae plant comprises a tomato plant.

22. The method of claim 16, wherein the Chlorella cells have not been subjected to a drying process.

23. The method of claim 16, wherein the Chlorella cells are cultured in mixotrophic conditions.

24. The method of claim 23, wherein the Chlorella cells are cultured in non-axenic mixotrophic conditions.

25. The method of claim 16, wherein the liquid composition treatment does not contain an active ingredient for enhancing emergence of seeds other than the culture of whole Chlorella cells.

26. The method of claim 16, wherein the liquid composition treatment further comprises stabilizing means suitable for plants.
